(19) United States
(12) Patent Application Publication
(10) Pub. No.: US 2015/0021491 A1
(43) Pub. Date: Jan. 22, 2015

(54) METHOD AND APPARATUS FOR MEASURING CONCENTRATION OF ADVANCED-OXIDATION ACTIVE SPECIES

(71) Applicant: KURASHIKI BOSEKI KABUSHIKI KAISHA, Kurashiki (JP)

(72) Inventors: Noboru Higashi, Neyagawa (JP); Naomi Kariyama, Neyagawa (JP); Yukihiro Ozaki, Sanda (JP); Yusuke Morisawa, Sanda (JP); Akifumi Ikehata, Tsukuba (JP); Takeyoshi Goto, Tsukuba (JP)

(21) Appl. No.: 14/505,264

(22) Filed: Oct. 2, 2014

Related U.S. Application Data
(62) Division of application No. 13/735,934, filed on Jan. 7, 2013.

(30) Foreign Application Priority Data
Sep. 3, 2012 (JP) 2012-193266

(51) Int. Cl. G01N 21/61

(52) U.S. Cl. CPC G01N 21/61
USPC 250/372

(57) ABSTRACT

A method for measuring the concentration of advanced-oxidation active species includes a step of measuring the absorption characteristics of a wavelength region including the wavelength of 195 to 205 nm of a sample and a step of determining the concentration of the advanced-oxidation active species from the aforementioned measured absorption characteristics on the basis of the absorption coefficient of the advanced-oxidation active species in the wavelength region including the wavelength of 195 to 205 nm. The method and the apparatus can measure the concentration of the advanced-oxidation active species directly in line without the need for adding an additive.

### CROSS-REFERENCE TO RELATED APPLICATIONS

This application is a divisional of U.S. application Ser. No. 13/735,934, filed on Jan. 7, 2013, which claims priority to Japanese Patent Application No. 2012-193266, filed Sep. 3, 2012, which are hereby incorporated by reference in their entirety.

### BACKGROUND OF THE INVENTION

1. Field of the Invention

The present invention relates to a method and an apparatus for measuring the concentration of advanced-oxidation active species which are active species generated in an advanced oxidation process, and is a technique useful in measuring the change with lapse of time of the concentration of active species such as hydroxyl radicals in a microsecond order.

2. Description of the Related Art

The advanced oxidation process is a method that processes an object article by generating active radical species having a strong oxidation power such as hydroxyl radicals using physicochemical processing techniques such as ozone, hydrogen peroxide, and ultraviolet rays in combination. In recent years, such an advanced oxidation process is adopted not only in water processing but also in the field of semiconductor cleaning processes and others.

In the field of semiconductor cleaning processes and others, management of the concentration of the processing liquid will be important, so that the measurement of the concentration of (for example, hydroxyl radicals) is becoming more important. For such measurement of the concentration of water-soluble radicals, electron spin resonance (ESR) is generally used. However, in ESR, since the water-soluble radicals (in particular, hydroxyl radicals) have an extremely short lifetime, the measurement must be carried out after adding a spin trap agent.

Therefore, a method of using a total-reflection damping-type far-ultraviolet spectrometer is proposed as a method for measuring the concentration of water-soluble radicals in the place where they are generated, in a non-invasive manner and in real time without pre-processing such as mixing an additive (see, for example, JP-A-2011-75447).

Also, there is known a method of measuring the concentration of hydroxyl radicals by adding a reactive substance that reacts instantaneously with the hydroxyl radicals to a measurement target liquid and calculating the amount of decrease caused by side reaction (see, for example, JP-A-2011-242166).

### SUMMARY OF THE INVENTION

However, according to the measurement method disclosed in JP-A-2011-75447, change in the concentration of hydroxyl radicals is measured indirectly from the influence that the hydroxyl radicals give to the surrounding water molecules. Also, according to the measurement method disclosed in JP-A-2011-242166, the concentration of hydroxyl radicals is calculated by reverse calculation from the amount of decrease in the absorbance of a substance that has reacted with the hydroxyl radicals. In this manner, by a method of indirectly measuring the hydroxyl radicals, there is a fear in measurement errors and delay in detection.

The reason why there is not a method of directly measuring the hydroxyl radicals in spite of the above fact seems to be as follows. Namely, the absorption coefficient of hydroxyl radicals around 200 nm is not known, and also the absorption coefficient in a wavelength region of 210 nm or longer is not characteristic as compared with other active species, and moreover, the generated concentration thereof is low, so that it has been difficult to separate the concentration-time profile of hydroxyl radicals from the absorbance profile of the sample.

Thus, an object of the present invention is to provide a method and an apparatus for measuring the concentration of advanced-oxidation active species that can measure the concentration of the advanced-oxidation active species directly in line without the need for adding an additive.

By analyzing the absorbance profile of samples, the present inventors have found out that a specific absorption coefficient of advanced-oxidation active species is present in a wavelength region of a wavelength of 195 to 205 nm and that, by using this, the concentration of the advanced-oxidation active species can be directly measured, thereby completing the present invention.

Specifically, a method for measuring a concentration of advanced-oxidation active species of the present invention, comprises:

a step of measuring absorption characteristics of a wavelength region including a wavelength of 195 to 205 nm of a sample; and

a step of determining the concentration of the advanced-oxidation active species from the measured absorption characteristics on a basis of an absorption coefficient of the advanced-oxidation active species in the wavelength region including the wavelength of 195 to 205 nm. In the present invention, the “advanced-oxidation active species” refer to the active species that are generated at the time of advanced oxidation process, and specifically contain hydroxyl radicals as a major component and also contain active oxygen species and others such as HOO radicals that are generated as derivative radicals thereof.

According to the method for measuring the concentration of advanced-oxidation active species of the present invention, the concentration of the advanced-oxidation active species is determined from the absorption characteristics of the samples on the basis of the specific absorption coefficient (factor 3-c) of the advanced-oxidation active species in the wavelength region of the wavelength of 195 to 205 nm such as shown in FIG. 9A, so that the concentration of the advanced-oxidation active species can be measured directly in line without the need for adding an additive.

In the above, it is preferable that the sample contains ozone and hydrogen peroxide, and, in the step of determining the concentration of the advanced-oxidation active species, the concentration of the advanced-oxidation active species is determined from the measured absorption characteristics on the basis of the absorption coefficients of the advanced-oxidation active species, ozone, and hydrogen peroxide in the wavelength region including the wavelength of 195 to 205 nm. In the advanced oxidation process, the concentration change of the three components such as this will be important. In a system assuming these three components as premises, the absorption coefficient of each is characteristic, so that it will be easy to separate the concentration-time profile of the advanced-oxidation active species from the absorbance profile of the samples, whereby concentration measurement having a higher precision can be carried out.

Also, it is preferable to further comprise a step of measuring a change in the absorption characteristics immediately after radiation in the wavelength region including the wavelength of 195 to 205 nm by radiating excitation light to an aqueous solution containing ozone, thereafter determining each of the optimum solutions of the absorption coefficients and concentration-time profiles assuming two components as premises using known absorption coefficients of ozone and hydrogen peroxide as initial values, and thereafter determining each of the optimum solutions of the absorption coefficients and concentration-time profiles assuming three components as premises using, as an initial value, the absorption coefficient of a third component that is determined from a difference between an absorbance profile calculated from the optimum solutions and an absorbance profile actually measured, thereby to determine the concentration of the advanced-oxidation active species.

Known absorption coefficients of ozone and hydrogen peroxide each have a characteristic profile (absorption coefficient change for each wavelength), and show a characteristic concentration-time profile of increasing type and decreasing type immediately after radiation when excitation light is radiated to an aqueous solution of ozone. For this reason, an initial value of the absorption coefficient of the third component corresponding to the advanced-oxidation active species can be determined from the difference between the absorbance profile calculated from the optimum solutions of the absorption coefficients and the concentration-time profiles assuming these two components as premises and the absorbance profile actually measured. By using these and determining each of the optimum solutions of the absorption coefficients and the concentration-time profiles assuming the three components as premises, the absorption coefficient of the advanced-oxidation active species can be determined with a good precision.

In determining the initial value of the absorption coefficient of the third component from the difference between the absorbance profile calculated from the optimum solutions and the absorbance profile actually measured in the above-described manner, it is preferable to use a maximal value of an absorbance difference profile in each wavelength. The generated amount of the third component corresponding to the advanced-oxidation active species is slight, so that it is liable to be affected by noises. Therefore, by using the maximal value, the influence of the noises can be reduced, and the absorption coefficient of the third component that is more preferable as an initial value can be determined.

On the other hand, an apparatus for measuring a concentration of advanced-oxidation active species of the present invention, comprises:

a measurement unit for measuring absorption characteristics of a wavelength region including a wavelength of 195 to 205 nm of a sample; and

an operation unit for determining the concentration of the advanced-oxidation active species from the measured absorption characteristics on a basis of an absorption coefficient of the advanced-oxidation active species in the wavelength region including the wavelength of 195 to 205 nm.

According to the apparatus for measuring the concentration of advanced-oxidation active species of the present invention, the concentration of the advanced-oxidation active species is determined by the operation unit from the absorption characteristics of the samples on the basis of the specific absorption coefficient (factor 3-c) of the advanced-oxidation active species in the wavelength region of the wavelength of 195 to 205 nm such as shown in FIG. 9A, so that the concentration of the advanced-oxidation active species can be measured directly in line without the need for adding an additive.

In the above, it is preferable that the sample contains ozone and hydrogen peroxide, and, by the operation unit for determining the concentration of the advanced-oxidation active species, the concentration of the advanced-oxidation active species is determined from the measured absorption characteristics on the basis of the absorption coefficients of the advanced-oxidation active species, ozone, and hydrogen peroxide in the wavelength region including the wavelength of 195 to 205 nm.

In the advanced oxidation process, the concentration change of the three components such as this will be important. In a system assuming these three components as premises, the absorption coefficient of each is characteristic, so that it will be easy to separate the concentration-time profile of the advanced-oxidation active species from the absorbance profile of the samples, whereby concentration measurement having a higher precision can be carried out.

Also, it is preferable that the measurement unit comprises a light source for generating probe light, a cell for radiating the probe light, a spectroscope for dispersing the probe light emitted from the cell, and a detector for detecting an intensity of the dispersed light having a specific wavelength, and

the apparatus further comprises an excitation light source for generating pump light for exciting the sample in the cell, a control operation unit for determining change in the absorption characteristics of the sample immediately after radiation of the pump light by time-resolved measurement while controlling this excitation light source, and a sample exchanging unit for exchanging the samples. According to such a concentration measuring apparatus, the reaction of advanced oxidation can be reproduced within the cell, so that the absorption coefficient of the advanced-oxidation active species can be determined with a higher precision from the absorbance profile of the samples obtained by time-resolved measurement.

### BRIEF DESCRIPTION OF THE DRAWINGS

FIG. 1 is a view showing a time-resolved FUV spectrum of ozone water;

FIG. 2 is a view showing document values of molar absorption coefficients of O₃, H₂O₂, OH radicals, and HO₂ which are photoreaction chemical species of O₃ water;

FIGS. 3A and 3B are views showing molar absorption coefficients and concentration-time profiles, respectively, when the time-resolved spectrum of 0.690 mM ozone water is calculated in two components (O₃, H₂O₂);

FIG. 4 is a view showing a differential absorbance between the absorbance actually measured and the absorbance determined by calculation at 200 nm;

FIG. 5 is a view showing molar absorption coefficients when the time-resolved spectrum of 0.690 mM ozone water is calculated in three components (O₃, H₂O₂, OH.);

FIG. 6 is a view showing concentration-time profiles of OH. when the time-resolved spectra of 0.690 mM, 0.364 mM, and 0.183 mM ozone waters are calculated in three components (O₃, H₂O₂, OH.);

FIG. 7 is a view showing molar absorption coefficients when the time-resolved spectrum of 0.690 mM ozone water is calculated in three components (O₃, H₂O₂, HO₂.);

FIG. 8 is a view showing concentration-time profiles of HO₂ when the time-resolved spectra of 0.690 mM, 0.364 mM, and 0.183 mM ozone waters are calculated in three components (O₃, H₂O₂, HO₂.);

FIGS. 9A and 9B are views showing molar absorption coefficients and concentration-time profiles of transient species, respectively, when the time-resolved spectrum of 0.690 mM ozone water is calculated in three components (O₃, H₂O₂, transient species);

FIG. 10 is a view showing a differential absorbance between the absorbance actually measured and the absorbance determined by calculation at 200 nm;

FIG. 11 is a view showing comparison of the molar absorption coefficient of the third component;

FIG. 12 is a flowchart showing steps of calculating the absorption coefficient of advanced-oxidation active species;

FIG. 13 is a block diagram showing one example of a measuring apparatus used in calculating the absorption coefficient of advanced-oxidation active species; and

FIG. 14 is a block diagram showing one example of an apparatus for measuring the concentration of advanced-oxidation active species according to the present invention.

### DETAILED DESCRIPTION OF THE PREFERRED EMBODIMENTS

### (Calculation of Absorption Coefficient of Advanced-Oxidation Active Species)

The method for measuring the concentration of advanced-oxidation active species of the present invention includes a step of determining the concentration of the advanced-oxidation active species from the aforementioned measured absorption characteristics on the basis of the absorption coefficient of the advanced-oxidation active species in the wavelength region including the wavelength of 195 to 205 nm. The absorption coefficient of the advanced-oxidation active species in the wavelength region including the wavelength of 195 to 205 nm has not been known up to now, and also the advanced-oxidation active species are transient species, so that it has been difficult to prepare a calibration line. As will be described below, the present inventors have found out that a specific absorption coefficient of the advanced-oxidation active species exists in the wavelength region of 195 to 205 nm by analyzing the absorbance profile of the samples that reproduce the reaction of the advanced-oxidation process.

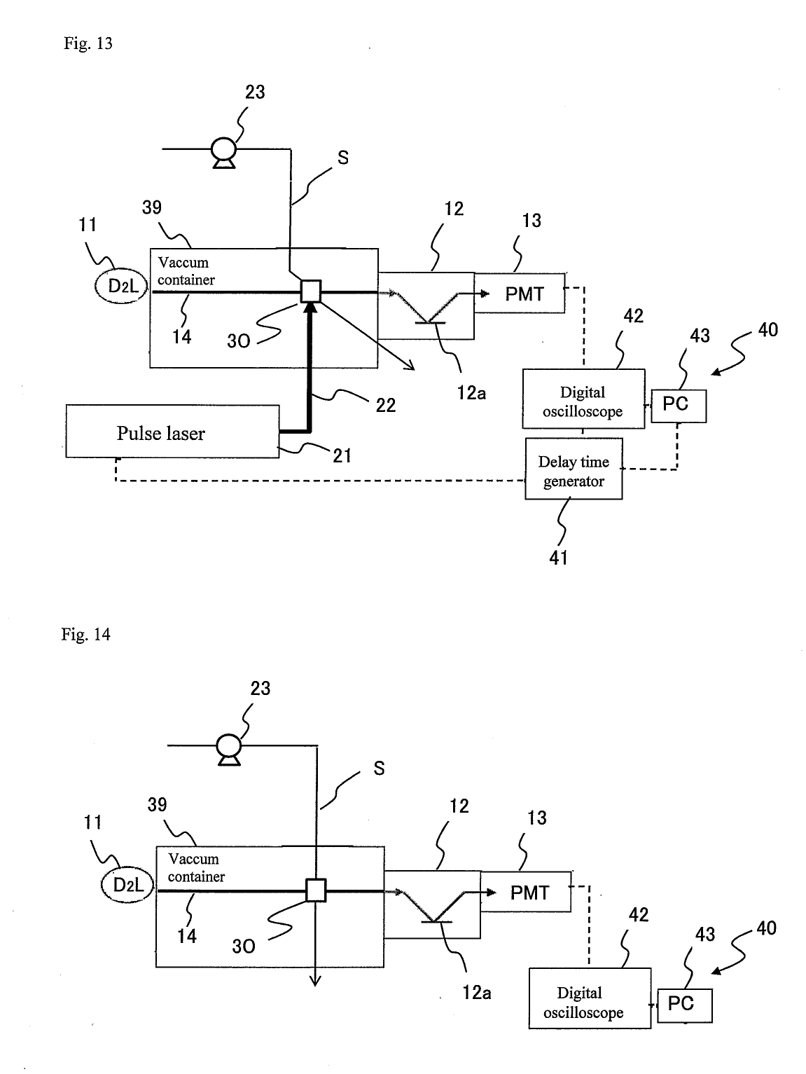

First, change in the absorption characteristics immediately after radiation in the wavelength region including the wavelength of 195 to 205 nm by radiating excitation light to an aqueous solution containing ozone. Specifically, with use of a pump-probe type far ultraviolet transmission spectroscope such as shown in FIG. 13, the time-resolved spectrum of ozone water was measured. By using an Nd:YAG laser having a pulse width of 10 ns as the pump light (excitation light), the probe light that has been transmitted through a sample with an optical path length of 5 mm was detected with a photoelectron multiplier tube (PMT) by after-spectrometry. The measurement time region was set to be 50 ms before and after the pump light radiation, and signals were taken in at a 1 ns interval.

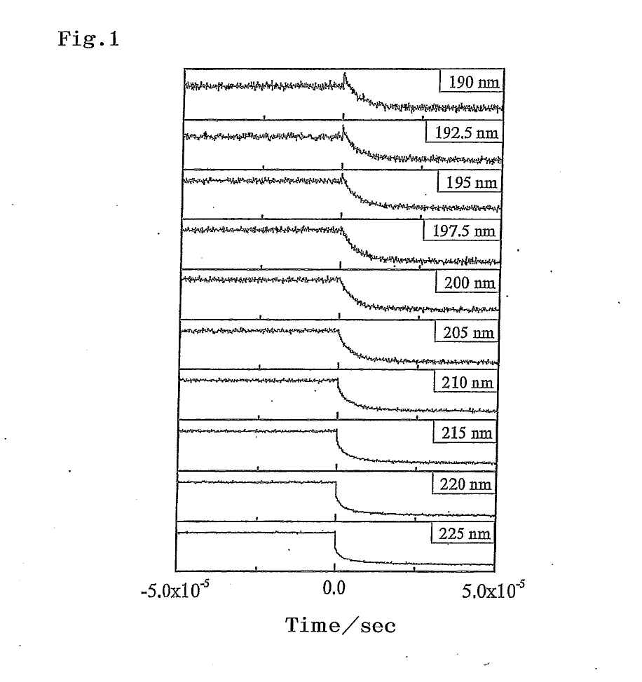

The measured spectrum of the ozone water is shown in FIG. 1. On the shorter-wavelength side (190 to 200 nm) of measurement, a positive absorbance change of about 0.01 was shown immediately after the pump light radiation, and thereafter a negative absorbance change was shown. On the longer-wavelength side (210 to 225 nm), a negative absorbance change was shown from immediately after the pump light radiation.

Next, each of the optimum solutions of the absorption coefficients and concentration-time profiles assuming two components as premises is determined using known absorption coefficients of ozone and hydrogen peroxide as initial values. The method of analysis therefor is as follows.

(1) Absorbance change (DAbs) is calculated from the signal values taken into an oscilloscope.
(2) In DAbs, high-frequency components are removed with a Fourier transform filter.
(3) An absorbance matrix A (time, wavelength channel) is prepared, and the matrix A is linearly decomposed into a molar absorption coefficient matrix S and a concentration-time profile matrix C in accordance with the Lambert-Beer law. For searching for the optimum solutions, multivariate curve resolution (MCR) is repetitively carried out on the absorbance matrix A by alternating least squares (ALS).

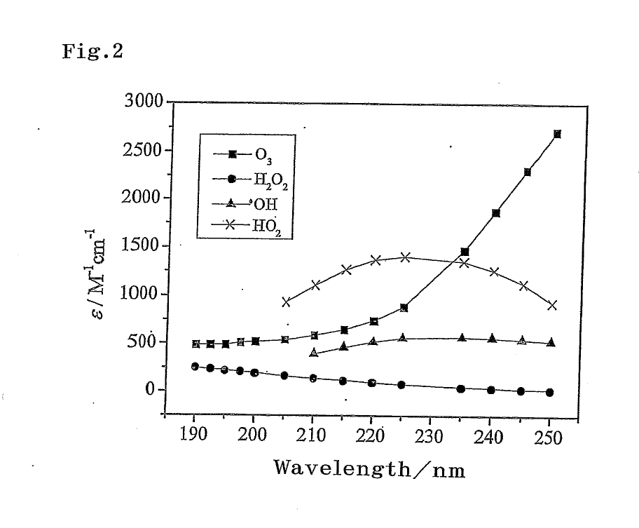

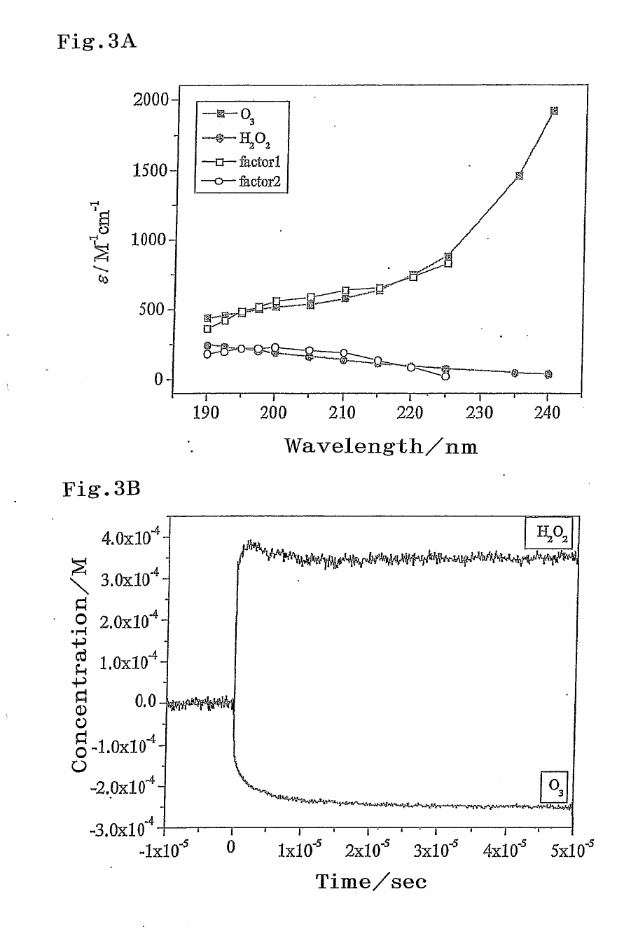

Specifically, with the measured time-resolved spectrum of O₃, the optimum solutions of the molar absorption coefficient and the change of concentration with lapse of time are determined from the absorbance matrix A of the spectrum thereof by the MCR-ALS method. For the initial values of the molar absorption coefficient, document values of photoreaction chemical species of O₃ water shown in FIG. 2 were used. Principally, the positive absorbance change seems to show the generation of H₂O₂, and the negative change seems to be derived from the decomposition of O₃. Therefore, first, the molar absorption coefficient matrix (S) and the concentration-time profile matrix (C) of two components were extracted by using the molar absorption coefficients of O₃ and H₂O₂, whereby molar absorption coefficients and concentration-time profiles such as shown in FIG. 3A to 3B were obtained.

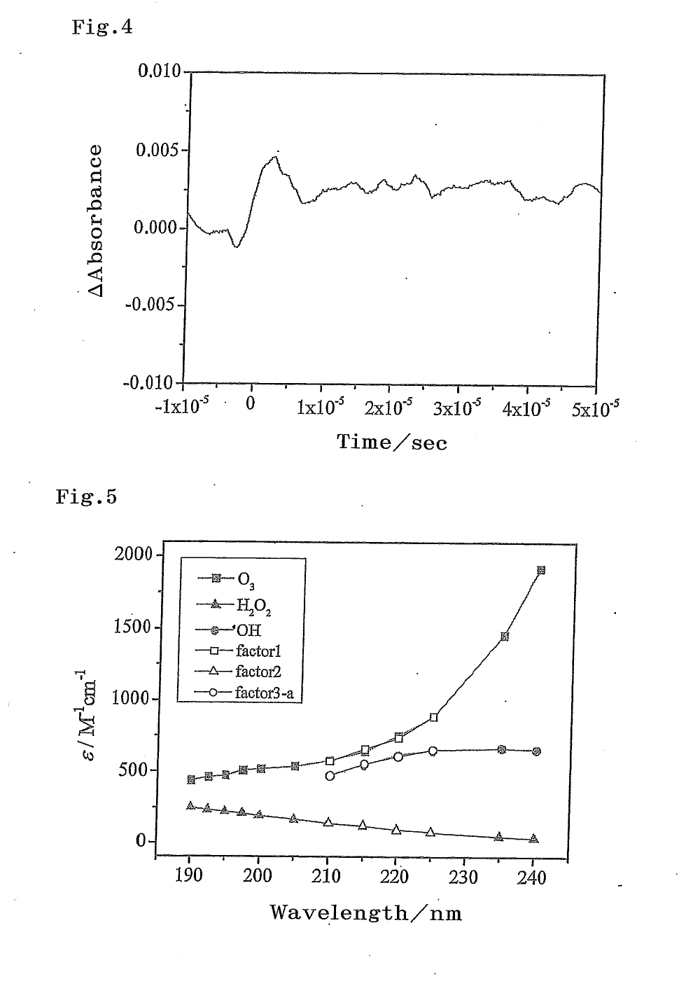

When S (factors 1 to 2) which was the calculated value was compared with the document value, a little shift was seen in the wavelength of 200 to 210 nm. For this reason, an absorbance matrix (Ar2) was calculated from the molar absorption coefficient S and the concentration-time profile C that had been fit in two components, and a difference (residual matrix: R2=A−Ar2) from the actually measured absorbance matrix A was examined, whereby a definite signal shape remained with the wavelength of 200 nm being at the center. The differential absorbance at 200 nm is shown in FIG. 4. From this fact, it seemed that the measured time-resolved spectrum contained change in the reaction transient species (advanced-oxidation active species) other than O₃ and H₂O₂.

Subsequently, in the present invention, an initial value of the absorption coefficient of a third component that was determined from a difference between the absorbance profile calculated from the optimum solutions assuming two components as premises and the absorbance profile actually measured, and each of the optimum solutions of the absorption coefficients and concentration-time profiles assuming three components as premises was determined.

For the purpose of comparison with such a method, each of the optimum solutions of the absorption coefficients and concentration-time profiles assuming three components as premises was determined in the wavelength region of 210 to 225 nm where document values of OH radicals exist, using known absorption coefficients as initial values.

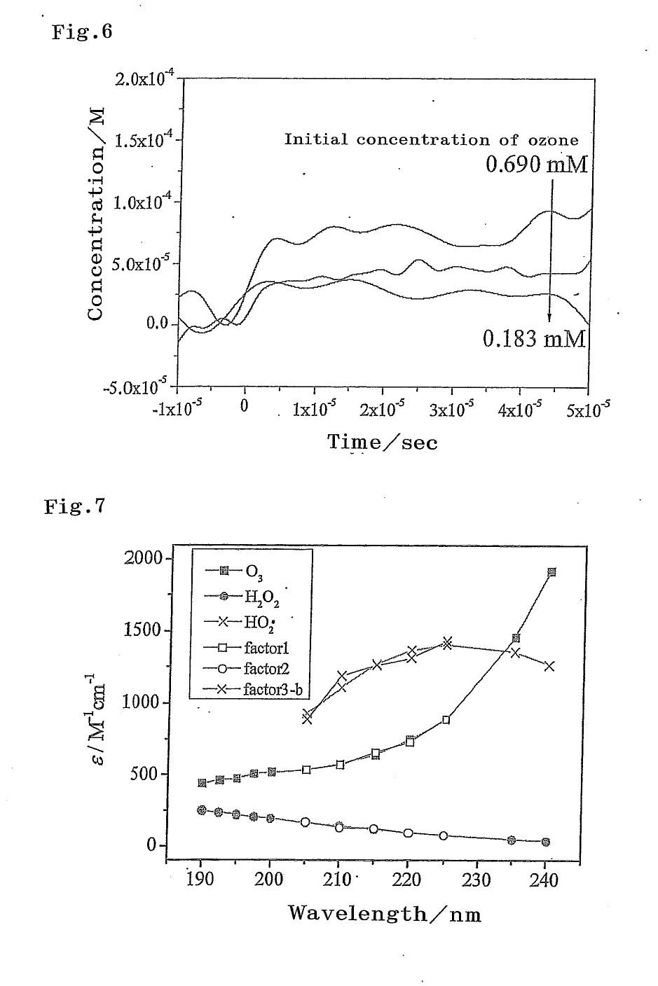

FIGS. 5 and 6 show S and C when fitting was made using the molar absorption coefficient of OH radicals as the initial value of the third component. The first and second components of C are almost identical with the results shown in FIG. 3 where fitting is carried out in two components, so that only the third component is shown in enlargement. When S (factors 1 to 3-a) which is the calculated value is compared with the document value, it will be understood that a fairly good coincidence is shown. However, as shown in FIG. 6, regarding the third component of C, the concentration profile of the third component when the initial concentration of ozone changed is not correctly observed, so that it has been found out that the method of using the document values of the molar absorption coefficient of OH radicals gives a low measurement precision.

On the other hand, in the wavelength region of 205 to 225 nm where the document values of HO₂ radicals exist, each of the optimum solutions of the absorption coefficients and concentration-time profiles assuming three components as premises was determined using known absorption coefficients as initial values.

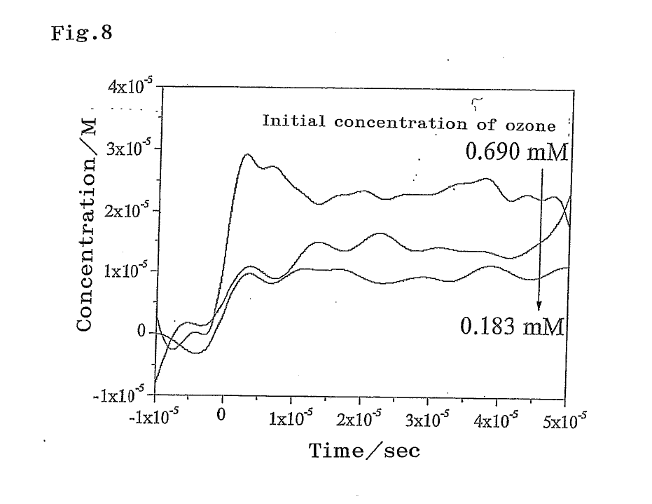

FIGS. 7 and 8 show S and C when fitting was made using the molar absorption coefficient of HO₂ as the initial value of the third component. In the same manner as described above, the first and second components of C are almost identical with the results shown in FIG. 3 where fitting is carried out in two components, so that only the third component is shown in enlargement. When S (factors 1 to 3-b) which is the calculated value is compared with the document value, it will be understood that a fairly good coincidence is shown. However, as shown in FIG. 8, regarding the third component of C, the concentration profile of the third component when the initial concentration of ozone changed is not correctly observed, so that it has been found out that also the method of using the document values of the molar absorption coefficient of HO₂ radicals gives a low measurement precision.

As described above, by the method of using the document values of the molar absorption coefficient of radicals which are considered as the advanced-oxidation active species, the measurement precision is low. Therefore, in the present invention, it is preferable that each of the optimum solutions of the absorption coefficients and concentration-time profiles assuming three components as premises is determined in a wider wavelength range, and the absorption coefficient of the advanced-oxidation active species is determined from the results thereof. Also, it is preferable that a maximal value of the absorbance difference profile in each wavelength is used in determining the initial value of the absorption coefficient of the third component from the difference between the absorbance profile calculated from the optimum solutions and the absorbance profile actually measured.

Specifically, on the molar absorption coefficient of transient species that are considered from the reaction, there are no reported documents up to 190 nm. Therefore, the molar absorption coefficient of the third component was extracted from the residual matrix R2 when fitting was made with two components. By plotting the maximal value of each wavelength of the residual matrix R2, the shape of the molar absorption coefficient of the third component up to 190 nm was determined, and this value was examined as the initial value.

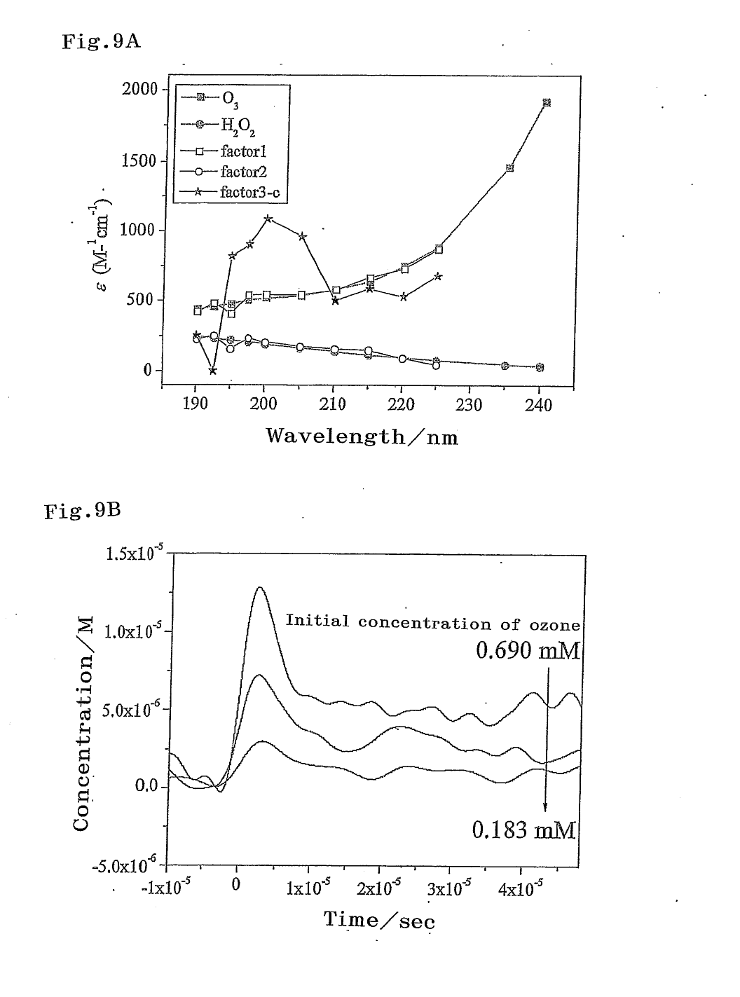

FIG. 9 shows S and C of the result of fitting. As shown in FIG. 9A, it will be understood that, in the wavelength region of the wavelength of 195 to 205 nm, the advanced-oxidation active species have a specific absorption coefficient (factor 3-c). In the present invention, the concentration of the advanced-oxidation active species is determined from the absorption characteristics of a sample based on this, so that the concentration of the advanced-oxidation active species can be measured directly at a good precision.

As shown in FIG. 9B, regarding the third component of C, the concentration profile of the third component when the initial concentration of ozone changes is correctly observed. Therefore, it has been found out the measurement precision is high as compared with the method of using the document values of the molar absorption coefficient.

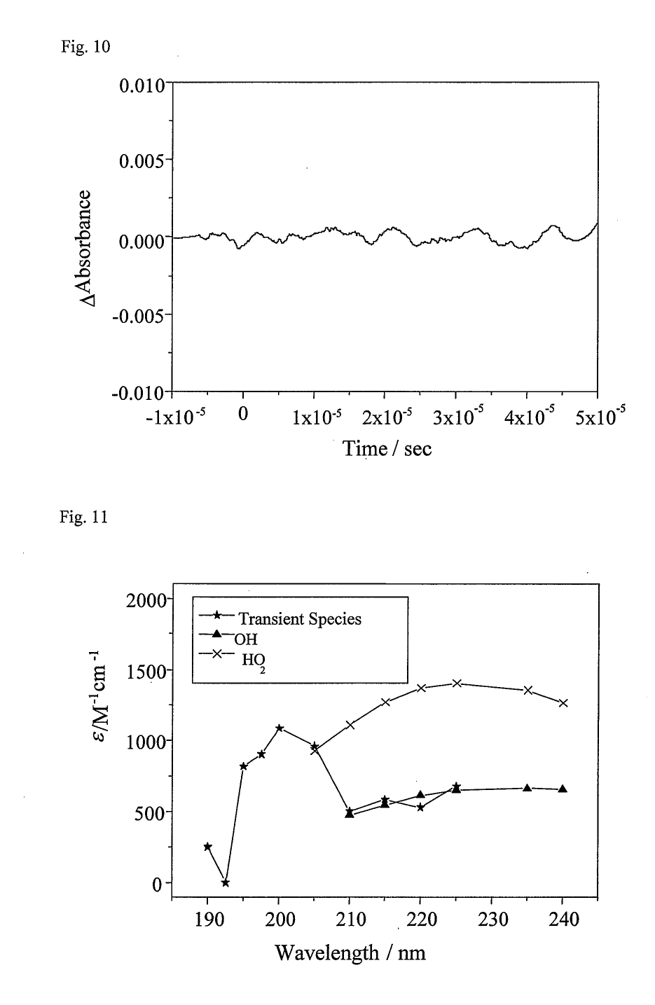

Also, an absorbance matrix (Ar3) was calculated in the same manner as the two components, and a difference (residual matrix: R3=A−Ar3) from the actually measured absorbance matrix A was examined, where it was a white noise at any wavelength. Therefore, it has been concluded that, regarding the linear decomposition of the absorbance matrix A, consideration of up to the third component is sufficient. The differential absorbance at 200 nm at that time is shown in FIG. 10.

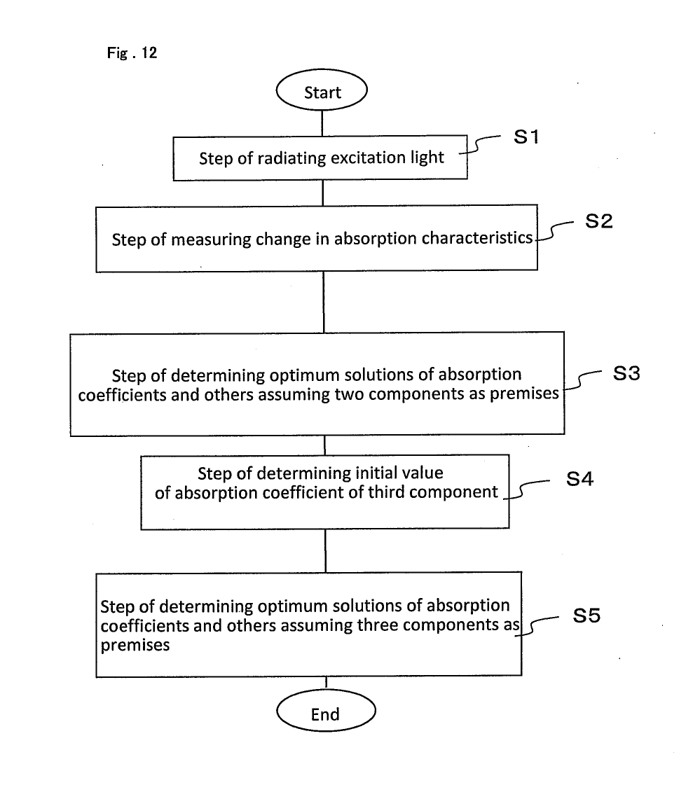

When the molar absorption coefficient of the third component is compared, it will be understood that it is a numerical value of the same degree as the value of the radical species that are considered to be generated as shown in FIG. 11. Since there are no document values up to 190 nm, assertion of transient species cannot be made; however, it will be understood that some kind of transient species has been measured.

The flowchart of the above-described steps is shown in FIG. 12. As shown in FIG. 12, it is preferable that the method for measuring a concentration of advanced-oxidation active species according to the present invention further includes a step (S2) of measuring a change in the absorption characteristics immediately after radiation in the wavelength region including the wavelength of 195 to 205 nm by (S1) radiating excitation light to an aqueous solution containing ozone, thereafter (S3) determining each of the optimum solutions of the absorption coefficients and the concentration-time profiles assuming two components as premises using known absorption coefficients of ozone and hydrogen peroxide as initial values, and thereafter (S5) determining each of the optimum solutions of the absorption coefficients and the concentration-time profiles assuming three components as premises by (S4) determining an initial value of the absorption coefficient of a third component from a difference between an absorbance profile calculated from the optimum solutions and an absorbance profile actually measured, thereby to determine the absorption coefficient of the aforesaid advanced-oxidation active species.

The absorption coefficient of the advanced-oxidation active species (third component) determined by these steps is calculated as one component; however, as actual components, not only one component (hydroxyl radicals) but also a plurality of components may be included.

### (Method for Measuring Concentration of Advanced-Oxidation Active Species)

The method for measuring a concentration of advanced-oxidation active species according to the present invention includes a step of measuring absorption characteristics of a wavelength region including a wavelength of 195 to 205 nm of a sample and a step of determining the concentration of the advanced-oxidation active species from the aforesaid measured absorption characteristics on the basis of an absorption coefficient of the advanced-oxidation active species in the wavelength region including the wavelength of 195 to 205 nm.

The step of measuring the absorption characteristics can be carried out by measurement that accords to a general absorptiometry method with respect to the wavelength region including the wavelength of 195 to 205 nm, for example, by using a measurement apparatus or the like described later. In principle, light of a wavelength region including the wavelength of 195 to 205 nm can be radiated into a cell that accommodates a sample, and the absorbance characteristics can be measured from the intensity of the transmitted light.

As the wavelength region including the wavelength of 195 to 205 nm, it may be a wavelength region of only the wavelength of 195 to 205 nm; however, from the viewpoint of enhancing the precision of the measurement of each of the components including the components other than the advanced-oxidation active species, a wavelength region of the wavelength of 190 to 240 nm is preferable, and a wavelength region of the wavelength of 185 to 320 nm is more preferable.

The present invention is characterized in that the concentration of the advanced-oxidation active species is determined from the aforesaid measured absorption characteristics on the basis of the absorption coefficient of the advanced-oxidation active species in the wavelength region including the wavelength of 195 to 205 nm. Therefore, regarding the step of measuring the absorption characteristics, any of the measurement methods that accord to conventional absorptiometry methods can be adopted except that the measurement is carried out in the wavelength region including the wavelength of 195 to 205 nm.

The sample may be any one of the systems where advanced-oxidation active species are present or generated; however, it is preferably a processing liquid used when advanced oxidation process that uses a physicochemical processing technique such as ozone, hydrogen peroxide, or ultraviolet ray in combination is carried out. Such a processing liquid contains ozone and hydrogen peroxide in addition to the advanced-oxidation active species.

The step of determining the concentration of the advanced-oxidation active species is characterized by using the absorption coefficient of the advanced-oxidation active species in the wavelength region including the wavelength of 195 to 205 nm. Further, regarding the absorption coefficient of such advanced-oxidation active species, suitable document values are not present, and it has been difficult to prepare a calibration line because the advanced-oxidation active species are transient species. For this reason, as the absorption coefficient of the advanced-oxidation active species, it is preferable to use a value calculated by the above-described method. Here, this value is a physical multiplier number and can be used as an initial value at the time of concentration measurement. Therefore, there is no need to calculate it every time from the difference between the absorbance profile and the actually measured absorbance profile for each time of the measurement.

Specifically, as shown in FIG. 9A, for the molar absorption coefficient of the wavelength region of the wavelength of 195 to 205 nm, a value of about 820 M⁻¹cm⁻¹ for the wavelength of 195 nm, a value of about 900 M⁻¹cm⁻¹ for the wavelength of 197.5 nm, a value of about 1100 M⁻¹cm⁻¹ for the wavelength of 200 nm, and a value of about 970 M⁻¹cm⁻¹ for the wavelength of 205 nm can be used. Part of these values may be used or further, in accordance with the above-described method, values of the absorption coefficient of the advanced-oxidation active species calculated for finer wavelengths in the wavelength region of the wavelength of 195 to 205 nm can be used.

Regarding the wavelength region other than the wavelength of 195 to 205 nm, the document values of hydroxyl radicals such as shown in FIG. 2 can be used; however, it is preferable to use a value calculated by the above-described method.

In order to determine the concentration of the advanced-oxidation active species from the measured absorption characteristics on the basis of the absorption coefficient of the advanced-oxidation active species such as this, the concentration can be determined from the absorbance, the molar absorption coefficient, and the optical path length of the cell on the basis of the Lambert-Beer law. Also, in the case of a sample containing a component other than the advanced-oxidation active species, the concentration of the advanced-oxidation active species can be determined from the absorbance at plural wavelengths, the molar absorption coefficient of each component at plural wavelengths, and the optical path length of the cell by the multicomponent simultaneous determination method. For this reason, the absorption characteristics can be measured in line, and the concentration of the advanced-oxidation active species as a calculation result can be displayed on screen or output as data in real time.

Also, in the present invention, it is preferable that the change with lapse of time of the concentration of the advanced-oxidation active species is measured in a microsecond order. In that case, in the same manner as in the step of determining the absorption coefficient of the advanced-oxidation active species such as described above, it is preferable to determine the change with lapse of time of the concentration of the advanced-oxidation active species by measuring the change of the absorption characteristics in the wavelength region including the wavelength of 195 to 205 nm and thereafter determining each of the optimum solutions of the absorption coefficients and the concentration-time profiles assuming the three components as premises using the absorption coefficient of the aforementioned advanced-oxidation active species and the known absorption coefficients of ozone and hydrogen peroxide as initial values.

The optimum solutions can be determined by the MCR-ALS method or the like, and the MCR-ALS method can be executed by using a commercially available software such as Matlab2010b (Mathworks Co., Ltd.).

Also, instead of using known absorption coefficients of ozone and hydrogen peroxide as initial values, the absorption coefficients of ozone and hydrogen peroxide obtained in determining each of the optimum solutions of the absorption coefficients and the concentration-time profiles assuming three components as premises may be used in the step of determining the absorption coefficient of the advanced-oxidation active species such as described above.

### (Apparatus for Measuring Concentration of Advanced-Oxidation Active Species)

First, a measurement apparatus used in calculation of the absorption coefficient of the advanced-oxidation active species will be described. Referring to FIG. 13, this measurement apparatus includes a light source 11 that generates probe light 14, a cell 30 to which the probe light 14 radiates, a spectroscope 12 that disperses the probe light 14 emitted from the cell 30, and a detector 13 that detects the intensity of a dispersed light having a specific wavelength.

Further, for performing time-resolved measurement, this measurement apparatus includes an excitation light source 21 that generates pump light 22 for exciting a sample S, a control operation unit 40 for controlling these, and a sample exchanging unit 23 for exchanging the samples.

The light source 11 is for generating the probe light 14 in a far ultraviolet wavelength region. The light source 11 may be any one that can generate light in an ultraviolet wavelength region, so that, for example, a deuterium lamp, a xenon lamp, or the like can be used, and also a lamp of laser-driven type can be used as well. The probe light 14 preferably includes an ultraviolet wavelength region of a wavelength of 195 to 205 nm.

The probe light 14 from the light source 11 is incident onto an incidence plane of the cell 30 after being condensed via a suitable optical system. The cell 30 has a quadrangular prismatic shape, where the four sides thereof correspond to the incidence plane and the exit plane of the probe light 14 and the incidence plane and the exit plane of the pump light 22, respectively. The bottom surface and the top surface of the cell 30 have a flow inlet part and a flow outlet part of the sample S. The space within the vacuum container 39 is degassed to vacuum.

The sample exchanging unit 23 is for exchanging the samples S accommodated in the cell 30. In the present embodiment, an example is shown in which the control operation unit 40 does not control the sample exchanging unit 23. In that case, supply of the samples S by the sample exchanging unit 23 may be a supply at a constant flow rate or an intermittent supply; however, it is preferable that samples S of a constant flow rate are supplied by the sample exchanging unit 23 because it is difficult to cope with a fast period of the pump light 22 and also the measurement time of one period is short.

As such a sample exchanging unit 23, any of the metering pumps such as a tube pump, a gear pump, and a syringe pump can be used. The sample S is sucked from a container not illustrated in the drawings and is discharged after radiation of the pump light 22.

The spectroscope 12 is an apparatus that disperses the probe light 14 emitted from the cell 30. As the spectroscope 12, a system using a prism or a grating mirror (diffraction grating) is present, and there are a system for measuring plural wavelengths at the same time and a system for measuring one wavelength at one time depending on a combination with the detector 13. In the present embodiment, an example of a system for measuring one wavelength at one time by using a grating mirror 12a is shown.

The spectroscope 12 of this system is constructed, for example, with an incidence slit, a collimator mirror, a grating mirror 12a, a condensing mirror, an exit slit, and others, and the selected wavelength can be changed by changing the optical path such as a slit position and the angle of the grating mirror 12a. As the method for optical arrangement of the spectroscope 12, there are a Czerny-Turner type, a Paschen-Runge type, and others. In the present invention, when measurement is carried out by plural wavelengths, the change with lapse of time of the absorption characteristics for each wavelength can be determined by repeating the measurement while changing the setting of the spectroscope 12.

Regarding the light of a specific wavelength dispersed by the spectroscope 12, the intensity thereof is detected by the detector 13. As the detector 13 of a system that measures one wavelength at one time, a photoelectron multiplier, a photodiode, and the like can be raised as examples. As the detector 13 of a system that measures plural wavelengths at the same time, a photodiode array, a CCD, and the like can be raised as examples. In the present invention, it is preferable to use a photoelectron multiplier from the viewpoint of enabling detection of faint light.

As the photoelectron multiplier, those having a sensitivity wavelength of 185 to 320 nm are preferable. Also, as the photoelectron multiplier, those having a rise time of 10 nanoseconds or less are preferable, and those having a rise time of 3 nanoseconds or less are more preferable, from the viewpoint of measuring the concentration change of the chemical species such as radicals in a nanosecond order.

The excitation light source 21 is for generating the pump light 22 for exciting the sample S. As the excitation light source 21, a pulse laser apparatus or the like capable of generating the pump light 22 in a time width of nanosecond to microsecond order by a trigger signal for pulse laser can be used.

The wavelength for exciting the sample S is determined in accordance with the kind of the sample S and the kind of generated reaction. For example, in the case in which it is intended to generate hydroxyl radicals from ozone water in an ultraviolet region, a wavelength of 250 to 270 nm can be selected. In the present embodiment, an example is shown in which a nanosecond pulse laser of 266 nm which is the fourth harmonic of Nd:YAG is used. This excitation light source 21 can control the timing for generating the pump light 22 by a trigger signal for pulse laser.

The control operation unit 40 performs control for periodically generating the pump light 22 by the excitation light source 21, operation of taking a detection signal from the aforesaid detector 13 into an integrator for integration by controlling the time interval between the generation of the pump light 22 and the take-in time gate that the integrator integrates, and operation for determining the change with lapse of time of the absorption characteristics from the integrated value that has been time-resolved by control of a plurality of time intervals.

In the present embodiment, an example is shown in which the control operation unit 40 includes a delay time generator 41, a digital oscilloscope 42 connected to this, and a personal computer (PC) 43 connected to these. Here, in FIGS. 13 and 14, the dotted line shows a state of being electrically connected.

The delay time generator 41 is connected to the excitation light source 21, and performs periodic generation of the pump light 22 by sending to the excitation light source 21 a trigger signal for pulse laser that controls the generation time (generation period and time width) of the pump light 22. The delay time generator 41 sends to the digital oscilloscope 42 a signal for timing control for controlling the time interval of the take-in time gate that the integrator integrates to the generation period of the pump light 22.

The digital oscilloscope 42 is an apparatus that performs digital signal analysis in real time while converting an analog signal to a digital signal by high-speed sampling (band width of 1 GHz or more), and those capable of gate integration by the integrator can be used. Also, in the present invention, the data processing including the gate integration by the integrator can be carried out on the PC 43 side as well. In the case in which the operation by the integrator is carried out in the digital oscilloscope 42 as in the former case, the time width of the take-in time gate that the integrator integrates may be set by the digital oscilloscope 42, and the timing of the time gate may be controlled by the signal from the delay time generator 41.

In the present invention, the time-resolved measurement can be carried out by control of a plurality of time intervals, for example, by setting the generation period of the pump light 22 to be 0.1 to 1 millisecond, setting the time width of the take-in time gate to be several to 10 nanoseconds, and changing the timing τ of the time gate after generation of the pump light 22.

At that time, the sensitivity of measurement can be enhanced to a further extent by obtaining an integrated value obtained by taking the detection signal from the detector 13 into the integrator for integration, by the take-in time gate at the same timing τ while keeping the time τ constant. As the integration times therefor, 10 times to ten thousand times are preferable, and 100 times to five thousand times are more preferable. By doing so, time-resolved measurement capable of one-photon detection can be carried out.

At that time, a preamplifier is preferably provided on the input side of the digital oscilloscope 42 in order to detect a faint signal from the detector 13. For example, a preamplifier having a response speed of about 50 nanoseconds and being capable of one-photon detection can be used.

The digital oscilloscope 42 has a memory that stores an integrated value and the like in association with the timing τ. By taking the data in by the PC 43 and performing data processing using a software for general use (for example, a table calculation software or the like), the change with lapse of time of the absorption characteristics can be determined from the time-resolved integrated value. In accordance with the needs, depicting a graph and the like can be carried out.

Also, by taking raw data in from the memory of the digital oscilloscope 42 and thereafter performing data processing including gate integration by the integrator, the change with lapse of time of the absorption characteristics can be determined from the time-resolved integrated value using a commercially available spectrum processing software installed into the PC 43.

In the present invention, it is preferable that the control by the control operation unit 40 is such that the time width of the pump light 22 is 1 to 10 nanoseconds; the take-in time gate is 10 nanoseconds to 10 microseconds; and the generation period of the pump light 22 is 100 milliseconds or less.

With regard to the measurement apparatus of the present embodiment, an example is shown in which the apparatus is constructed in a single-beam system as shown in FIG. 13. For this reason, in the case of determining the change with lapse of time of the difference in the absorbance by radiation of the pump light 22, it is necessary to determine the absorbance in a state in which the pump light 22 is not radiated.

Such background measurement can be carried out, for example, by making measurements with the same gate time and integration times immediately before radiation of the pump light 22. By subtracting the integrated value obtained by this from the time-resolved integrated value, the change with lapse of time of the difference in the absorbance by radiation of the pump light 22 can be determined.

Also, the background measurement can be separately carried out by making measurements with the same gate time and integration times without performing the radiation of the pump light 22 at all.

Next, an apparatus for measuring the concentration of advanced-oxidation active species according to the present invention will be described. Referring to FIG. 14, the concentration measurement apparatus of the present invention includes a measurement unit for measuring the absorption characteristics of a wavelength region including a wavelength of 195 to 205 nm of a sample, and an operation unit for determining the concentration of the advanced-oxidation active species from the aforesaid measured absorption characteristics on the basis of the absorption coefficient of the advanced-oxidation active species in the wavelength region including the wavelength of 195 to 205 nm.

In the same manner as the above-described apparatus, the measurement unit includes, for example, a light source 11 for generating probe light 14, a cell 30 for radiating the probe light 14, a spectroscope 12 for dispersing the probe light 14 emitted from the cell 30, and a detector 13 for detecting the intensity of the dispersed light having a specific wavelength.

The operation unit includes, for example, a digital oscilloscope 42 connected to the detector 13 and a personal computer (PC) 43 connected to this. Also, a delay time generator 41 may be provided, whereby a signal for timing control for controlling the time interval to the take-in time gate that the integrator integrates may be sent to the digital oscilloscope 42.

In the present invention, it is preferable that the operation unit determines the concentration of the advanced-oxidation active species from the aforesaid measured absorption characteristics on the basis of the absorption coefficients of the advanced-oxidation active species, ozone, and hydrogen peroxide in the wavelength region including the wavelength of 195 to 205 nm. Specifically, an operation for determining the concentration of the advanced-oxidation active species such as described above is carried out by the operation unit.

### OTHER EMBODIMENTS

(1) In the above-described embodiment, an example has been shown in which the concentration of the advanced-oxidation active species is determined using the value of the absorption coefficient of the advanced-oxidation active species shown in FIG. 9A as a premise. However, there is a possibility that the absorption coefficient of the advanced-oxidation active species may change a little when each of the optimum solutions of the absorption coefficients and the concentration-time profiles assuming three components as premises is determined by the concentration of the aqueous solution containing ozone, the conditions in radiating the excitation light, the conditions for measuring the absorption characteristics, and the like. In the present invention, it has been found out that a specific absorption coefficient of the advanced-oxidation active species exists in the wavelength region of the wavelength of 195 to 205 nm, and the concentration of the advanced-oxidation active species can be measured directly by using this. Therefore, the case such as described above in which the absorption coefficient of the advanced-oxidation active species that has changed a little is used is also naturally comprised within the technical scope of the present invention.
(2) In the above-described embodiment, an example has been shown in which the control operation unit 40 does not control the sample exchanging unit 23; however, by the control operation unit 40, control of exchanging the samples S by the sample exchanging unit 23 in synchronization with periodic generation of the pump light 22 by the excitation light source 21 may be carried out on the sample exchanging unit 23. Specifically, the delay time generator 41 can be connected to the sample exchanging unit 23, and a signal for timing control for exchanging the samples S in synchronization with a trigger signal for pulse laser that controls the generation time (generation period and time width) of the pump light 22 can be sent to the sample exchanging unit 23.
(3) In the above-described embodiment, an example of a system for measuring one wavelength at one time using the grating mirror 12a and the PMT 13 has been shown; however, a plurality of wavelengths can be measured simultaneously by using a photodiode array, a CCD, or the like as the detector 13. In that case, a device capable of performing A/D conversion by simultaneous input of a plurality of wavelength data is used as the control operation unit 40.
(4) In the above-described embodiment, an example has been shown in which the control operation unit 40 includes a delay time generator 41, a digital oscilloscope 42 connected to this, and a personal computer (PC) 43 connected to these; however, the control operation unit 40 can be constructed with a combination other than the combination of these.

For example, by using an I/O device having an A/D conversion function instead of the digital oscilloscope 42 and using a spectrum processing software provided on the personal computer (PC) 43 side, the change with lapse of time of the absorption characteristics can be determined from the time-resolved integrated value by control of a plurality of time intervals while taking the detection signal from the detector 13 into the integrator for integration on the basis of the signal for timing control from the delay time generator 41. Further, the PC 43 side may be allowed to have a function of the delay time generator 41.

(5) In the above-described embodiment, an example has been shown in which the total-reflection absorption measuring apparatus of the present invention is constructed with a single-beam system; however, the total-reflection absorption measuring apparatus of the present invention can also be constructed with a double-beam system. In that case, a device that divides the probe light 14 into two may be added, and a digital oscilloscope 42 capable of two-system input may be used by constructing the cell 30 of total-reflection damping type, the sample holding section 32, the spectroscope 12, and the detector 13 into two systems. Measurement of the background can be made by using the same solution as the sample S of the reference solution side and performing measurement at the same timing without radiating the pump light 22.

What is claimed is:

1. A method for measuring a concentration of advanced-oxidation active species, comprising:
a step of measuring absorption characteristics of a wavelength region including a wavelength of 195 to 205 nm of a sample; and
a step of determining the concentration of the advanced-oxidation active species from the measured absorption characteristics on a basis of an absorption coefficient of the advanced-oxidation active species in the wavelength region including the wavelength of 195 to 205 nm.

2. The method for measuring a concentration of advanced-oxidation active species according to claim 1, wherein
the sample contains ozone and hydrogen peroxide, and,
in the step of determining the concentration of the advanced-oxidation active species, the concentration of the advanced-oxidation active species is determined from the measured absorption characteristics on the basis of the absorption coefficients of the advanced-oxidation active species, ozone, and hydrogen peroxide in the wavelength region including the wavelength of 195 to 205 nm.

3. The method for measuring a concentration of advanced-oxidation active species according to claim 2, further comprising a step of measuring a change in the absorption characteristics immediately after radiation in the wavelength region including the wavelength of 195 to 205 nm by radiating excitation light to an aqueous solution containing ozone, thereafter determining each of the optimum solutions of the absorption coefficients and concentration-time profiles assuming two components as premises using known absorption coefficients of ozone and hydrogen peroxide as initial values, and thereafter determining each of the optimum solutions of the absorption coefficients and concentration-time profiles assuming three components as premises using, as an initial value, the absorption coefficient of a third component that is determined from a difference between an absorbance profile calculated from the optimum solutions and an absorbance profile actually measured, thereby to determine the concentration of the advanced-oxidation active species.

4. The method for measuring a concentration of advanced-oxidation active species according to claim 3, wherein a maximal value of an absorbance difference profile in each wavelength is used in determining the initial value of the absorption coefficient of the third component from the difference between the absorbance profile calculated from the optimum solutions and the absorbance profile actually measured.
